(19) United States
(12) Patent Application Publication
(10) Pub. No.: US 2019/0223091 A1
(43) Pub. Date: Jul. 18, 2019

(54) Enhancement of PLMN Selection in New Radio Networks

(71) Applicant: MEDIATEK INC., Hsinchu (TW)

(72) Inventors: Chien-Chun Huang-Fu, Hsinchu (TW); Hung Lin Chang, Hsinchu (TW)

(21) Appl. No.: 16/245,483

(22) Filed: Jan. 11, 2019

Related U.S. Application Data
(60) Provisional application No. 62/617,151, filed on Jan. 12, 2018.

(51) Int. Cl. H04W 48/18; H04W 48/14; H04W 76/15; H04L 27/26; H04L 5/00; H04W 72/12

(52) U.S. Cl. CPC H04W 48/18; H04W 48/14; H04W 72/1236; H04L 27/2666; H04L 5/0064; H04W 76/15

(57) ABSTRACT

A method of providing assistance information to improve the performance of Public Land Mobile Network (PLMN) selection is proposed. UE starts to perform PLMN selection procedure and searches for the first cell. The first cell can be an LTE cell or an NR cell served by a first base station. UE receives assistance information via system information broadcasted by the first base station. The assistance information comprises frequency band of NR/LTE cells, PLMN ID, subcarrier spacing (SCS) for NR cells, and RAT/system priority. UE then determines its PLMN/RAT preference, e.g., based on the availability of NR cells or LTE ENDC cells. Finally, UE continues the PLMN selection procedure searching for NR cell or LTE cell based on the assistance information.

### CROSS REFERENCE TO RELATED APPLICATIONS

This application claims priority under 35 U.S.C. § 119 from U.S. Provisional Application No. 62/617,151, entitled “Performance Enhancement for 5G Device”, filed on Jan. 12, 2018, the subject matter of which is incorporated herein by reference.

### TECHNICAL FIELD

The disclosed embodiments relate generally to wireless communication, and, more particularly, to method of enhancing PLMN selection in next generation new radio (NR) mobile communication systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards.

The signal bandwidth for next generation 5G new radio (NR) systems is estimated to increase to up to hundreds of MHz for below 6 GHz bands and even to values of GHz in case of millimeter wave bands. Furthermore, the NR peak rate requirement can be up to 20 Gbps, which is more than ten times of LTE. Three main application in 5G NR systems include enhanced Mobile Broadband (eMBB), Ultra-Reliable Low Latency Communication (URLLC), and massive Machine-Type Communication (MTC) under millimeter wave technology, small cell access, and unlicensed spectrum transmission. Multiplexing of eMBB & URLLC within a carrier is also supported.

There are many different system architecture options in 5G systems. For example, an E-UTRAN serving cell is capable of connecting to an evolved packet core (EPC) under 4G LTE or a 5G core (5GC) under 5G NR in standalone options. In addition, either E-UTRAN cell or NR cell can be used as an anchor cell connecting to either EPC or 5GC for dual connectivity (DC) in non-standalone options. Different core networks support different Non-Access Stratum (NAS) level signaling, while different radio access networks (RANs) supporting different AS level signaling via radio access technologies (RATs).

In Public Land Mobile Network (PLMN) selection and cell search procedure, a UE scans all RF channels in the frequency band according to its capabilities to find available PLMNs and suitable cells. On each carrier, the UE searches for the strongest cell according to the cell search procedure and read its system information in order to find out which PLMN the cell belongs to. After selecting a PLMN, the UE selects a suitable cell and the radio access mode based on idle mode measurement and cell selection criteria. If the UE is unable to find any suitable cell in the selected PLMN, the UE enters to “any PLMN/cell selection” state.

For UE that supports both LTE/NR access and core network signaling and various dual connectivity options, the default RAT preference is NR-RAN>LTE. However, in certain network deployment scenarios and geographic locations, there may not be available NR cells connecting to 5G core network. In the worst case, UE has to decode system information of all NR cells to know there is no NR cell connecting to 5GC and then start searching for LTE cells. A solution is sought for the network to provide UE with additional assistance information to improve the performance of PLMN selection.

### SUMMARY

A method of providing assistance information to improve the performance of Public Land Mobile Network (PLMN) selection is proposed. UE starts to perform PLMN selection procedure and searches for the first cell. The first cell can be an LTE cell or an NR cell served by a first base station. UE receives assistance information via system information broadcasted by the first base station. The assistance information comprises frequency band of NR/LTE cells, PLMN ID, subcarrier spacing (SCS) for NR cells, and RAT/system priority. UE then determines its PLMN/RAT preference, e.g., based on the availability of NR cells or LTE ENDC cells. Finally, UE continues the PLMN selection procedure searching for NR cell or LTE cell based on the assistance information.

In one embodiment, a UE performs a public land mobile network (PLMN) selection procedure and finding a first base station in a mobile communication network. The UE receives assistance information from the first base station for the PLMN selection procedure. The UE determines whether there are neighboring new radio (NR) cells supporting 5G core network services using the assistance information. The UE continues the PLMN selection and searching for NR cells when the assistance information indicates available 5G core network services. Otherwise the UE continues the PLMN selection and searching for LTE cells without completing the PLMN selection for NR cells.

In another embodiment, a UE performs a public land mobile network (PLMN) selection and finding an LTE base station in a mobile communication network. The UE receives assistance information from the LTE base station for the PLMN selection. The UE determines whether there are neighboring cells supporting EUTRA-NR dual connectivity (ENDC) using the assistance information. The UE continues the PLMN selection and searching for ENDC cells when the assistance information indicates available ENDC cells and when the UE also supports ENDC.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary next generation system with multiple access and core networks and a user equipment (UE) performing PLMN selection in accordance with one novel aspect.

FIG. 2 illustrates simplified block diagrams of a user equipment (UE) and a base station (BS) in accordance with embodiments of the current invention.

FIG. 3 illustrates one embodiment of PLMN selection procedure under a certain radio access technology (RAT) with assistance information in accordance with one novel aspect.

FIGS. 4A and 4B illustrate 5G system architecture with option 2 and option 4 supporting 5G core network connections and services.

FIGS. 5A and 5B illustrate 5G system architecture with option 1 and option 3 supporting 4G EPC network connections and services.

FIG. 6 illustrates one embodiment of providing assistance information by an NR base station or by an LTE base station for PLMN selection in accordance with one novel aspect.

FIG. 7 illustrates one embodiment of providing assistance information by an LTE base station for enabling EN-DC configuration in PLMN selection.

FIG. 8 is a flow chart of a method of receiving assistance information by a UE to determine proper RAT preference and improve PLMN selection performance in accordance with a novel aspect.

FIG. 9 is a flow chart of a method of receiving assistance information by a UE to determine dual connectivity options and improve PLMN selection performance in accordance with a novel aspect.

### DETAILED DESCRIPTION

Reference will now be made in detail to some embodiments of the invention, examples of which are illustrated in the accompanying drawings.

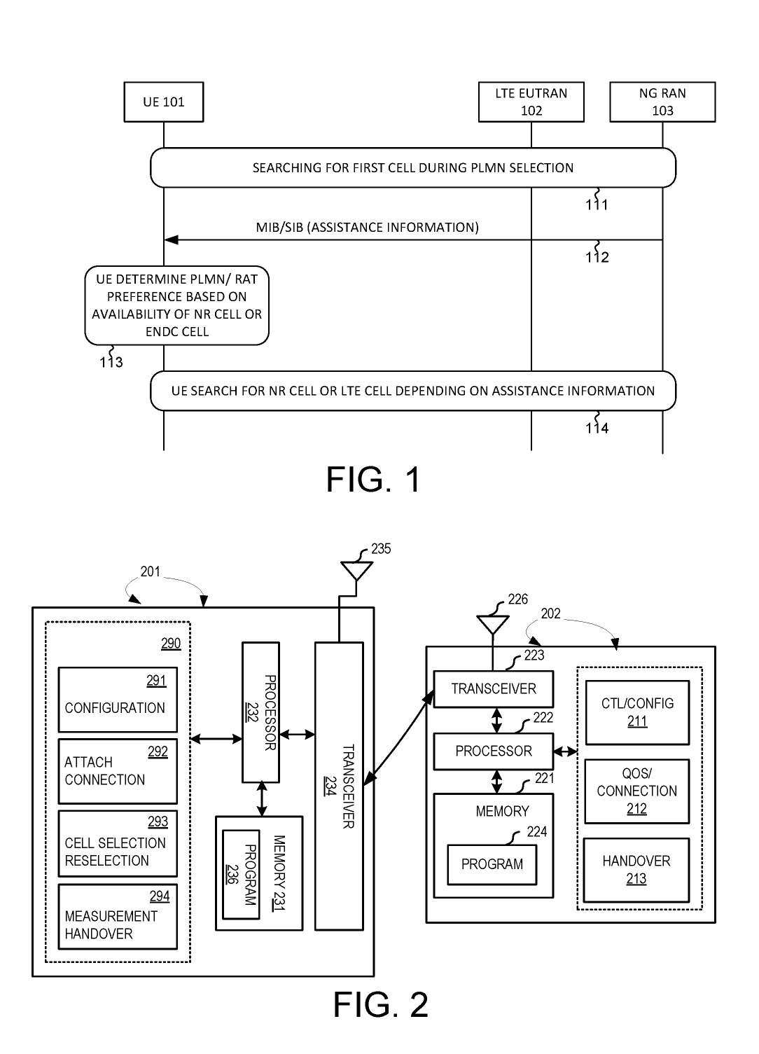

FIG. 1 illustrates an exemplary next generation 5G system with multiple access and core networks and a user equipment (UE) performing PLMN selection in accordance with one novel aspect. The 5G new radio (NR) mobile communication system comprises UE 101, an LTE E-UTRAN 102 connecting to a 4G evolved packet core (EPC) or a 5G core network (CN), and an NG radio access network (RAN) 103 connecting to a 4G EPC or a 5G CN. The radio access networks (RANs) provide radio access for UE 101 to the core networks via various radio access technologies (RATs). For example, UE 101 can access 4G EPC via E-UTRAN 102 in an LTE serving cell served by an LTE base station (eNB), and can access 5G CN via NG RAN 103 in an NR serving cell served by an NG base station (gNB). UE 101 may be equipped with a single radio frequency (RF) module or transceiver or multiple RF modules or transceivers for services via different RATs/CNs. UE 101 may support dual connectivity (DC). Different DC options may include EUTRA-NR DC (ENDC) anchored by LTE cell and NR-EUTRA DC (NEDC) anchored by NR cell. UE 101 may be a smart phone, a wearable device, an Internet of Things (IoT) device, a tablet, a machine-type communication (MTC) device, etc.

In Public Land Mobile Network (PLMN) selection and cell search procedure, a UE scans all RF channels in the frequency band according to its capabilities to find available PLMNs and suitable cells. On each carrier, the UE searches for the strongest cell according to the cell search procedure and reads its system information in order to find out which PLMN the cell belongs to. For UE that supports both 4G/5G access and core network signaling and various dual connectivity options, the default RAT preference is NG-RAN>LTE. However, in certain network deployment scenarios and geographic locations, there may not be available NR cells connecting to 5G CN. In the worst case, UE has to decode system information of all NR cells to know there is no NR cell connecting to 5G CN and then starts searching for LTE cells.

In accordance with one novel aspect, a method of providing assistance information to improve the performance of Public Land Mobile Network (PLMN) selection is proposed. In the example of FIG. 1, in step 111, UE 101 starts to perform PLMN selection procedure and searches for the first cell. The first cell can be an LTE cell or an NR cell served by a first base station. In step 112, UE 101 receives assistance information via system information broadcasted by the first base station. The assistance information comprises frequency band of NR/LTE cells, PLMN ID, subcarrier spacing (SCS) for NR cells, and RAT/system priority. In step 113, UE 101 determines its PLMN/RAT preference, e.g., based on the availability of NR cells or LTE ENDC cells. In step 114, UE 101 continues the PLMN selection procedure searching for NR cell or LTE cell based on the assistance information. UE 101 can update its RAT priority based on the availability of NR/LTE cells. As a result, UE 101 is able to find the preferred cell faster in the PLMN selection procedure.

FIG. 2 illustrates simplified block diagrams of a user equipment UE 201 and a base station BS 202 in accordance with embodiments of the current invention. BS 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in BS 202. Memory 221 may store program instructions and data 224 to control the operations of BS 202. BS 202 may also include a set of functional modules and control circuits, such as a control and configuration circuit 211 for control and configure system information including providing assistance information to UE, a connection circuit 212 for establish radio connection with UE, and a handover circuit 213 for sending handover commands to UE.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. UE 201 may also include a set of function modules and control circuits that may carry out functional tasks of the present invention. A configuration and control circuit 291 may receive system configuration and control information including assistance information from the network, an attach and connection circuit 292 may attach to the network and establish connection with a serving base station, a PLMN selection circuit 293 may perform PLMN and cell selection and reselection based on assistance information provided by the network, and a measurement and handover circuit 294 may perform measurements and handle handover functions in the network.

The various function modules and control circuits may be implemented and configured by software, firmware, hardware, and combination thereof. The function modules and circuits, when executed by the processors via program instructions contained in the memory, interwork with each other to allow the base station and UE to perform embodiments and functional tasks and features in the network. In one example, each module or circuit comprises a processor (e.g., 222 or 232) together with corresponding program instructions.

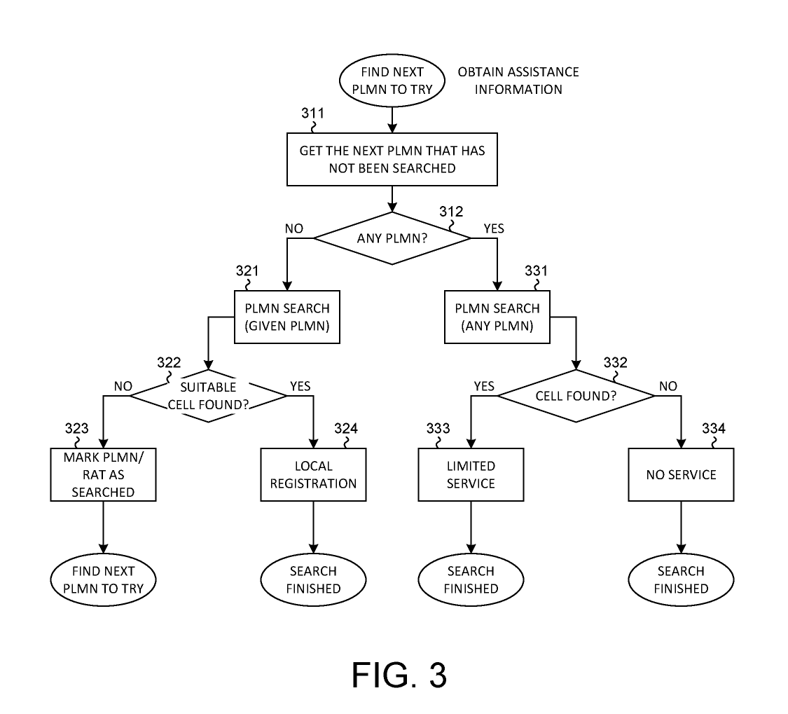

FIG. 3 illustrates one embodiment of PLMN selection procedure under a certain radio access technology (RAT) with assistance information in accordance with one novel aspect. In step 311, a UE performs PLMN selection by finding the next PLMN that has not been searched. The additional assistance information can help UE to determine which PLMN/RAT to search. In step 312, UE checks whether the search is for any PLMN. If yes, then UE performs PLMN search for any PLMN (331). If cell is found (332), then UE has limited service (333); otherwise, UE has not service (334) and search is finished. If the search is not for any PLMN, then UE performs PLMN search for a given PLMN (321). If a suitable cell is found (322), then UE performs local registration (324) and search is finished; otherwise, UE marks this PLMN/RAT has been searched (323) and find next PLMN to try.

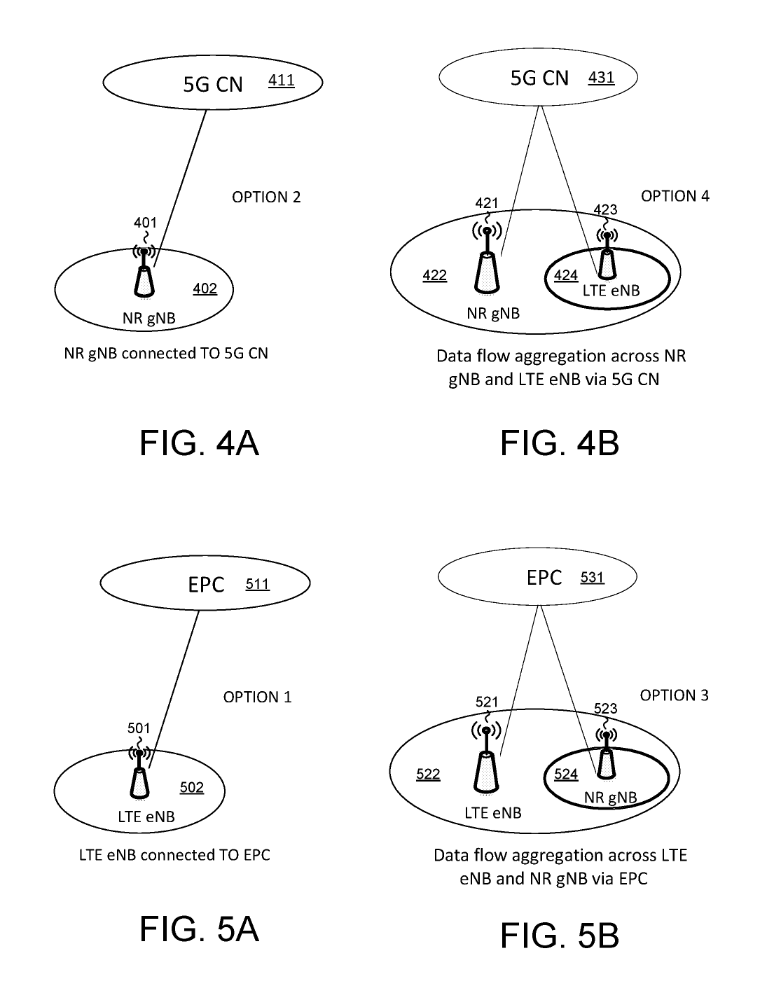

FIGS. 4A and 4B illustrate 5G system architecture with option 2 and option 4 supporting 5G core network connections and services. In the example of FIG. 4A, the 5G system comprises an NR gNB 401 connecting to a 5G CN 411 (option 2). NR gNB 401 serves NR cell 402 for NR services, and option 2 is a preferred option if such NR cell is available. In the example of FIG. 4B, the 5G system comprises an NR gNB 421 and an LTE eNB 423, both connecting to a 5G CN 431 (option 4). NR gNB 421 serves NR cell 422, while LTE eNB 423 served LTE cell 424. In one example, the NR cell is an anchor cell, and the LTE cell is a secondary cell, data flow aggregation across NR gNB and LTE eNB via 5G CN (NE-DC scenario).

FIGS. 5A and 5B illustrate 5G system architecture with option 1 and option 3 supporting 4G EPC network connections and services. In the example of FIG. 5A, the 5G system comprises an LTE eNB 501 connecting to an LTE EPC 511 (option 1). This is actually a 4G system, and option 1 may not be preferred option if 5G NR cell is available. In the example of FIG. 5B, the 5G system comprises an LTE eNB 521 and an NR gNB 523, both connecting to a 4G EPC 531 (option 3). LTE eNB 521 serves LTE cell 522, while NR gNB 523 served NR cell 524. In one example, the LTE cell is an anchor cell, and the NR cell is a secondary cell, data flow aggregation across LTE eNB and NR gNB via 4G EPC (EN-DC scenario). If option 2 is not available, then option 3 may be a preferred option when the UE supports EN-DC feature so that the NR gNB can increase the system throughput for UE via data aggregation.

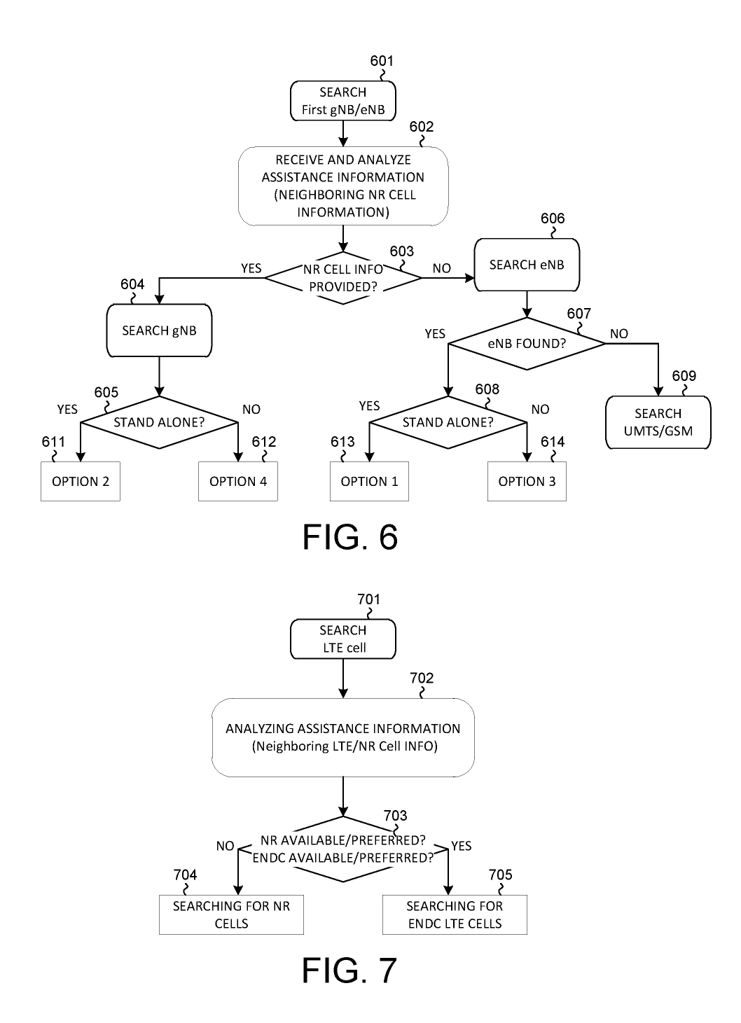

FIG. 6 illustrates one embodiment of providing assistance information by an NR base station or by an LTE base station for PLMN selection in accordance with one novel aspect. In step 601, UE starts PLMN selection by searching for a first base station, e.g., an NR gNB or an LTE eNB. Because 5G system provides enhanced services, UE can always starts searching for an NR gNB as a default priority. However, under certain network deployment scenario and geographic location, it may be faster for UE to search for an LTE eNB first so UE can choose to search for LTE eNB instead. If the first gNB/eNB is found, then UE goes to step 602.

In step 602, UE reads the system information block (SIB) or master information block (MIB) broadcasted by the first gNB/eNB. The SIB/MIB comprises assistance information to help UE perform PLMN selection with enhanced performance. In one example, the assistance information comprises available NG-RAN configuration including frequency band of NR cell, PLMN ID, subcarrier spacing (SCS) for NR cell, TTI for NR cell, or RAT/system priority.

The assistance information may be provided via NAS signaling (e.g., downlink NAS transport, configuration update procedure, etc.) Note that the indication of NR cells can be explicit or implicit. Upon receiving the assistance information, in step 603, UE determines whether there are neighboring NR cells available for 5G CN services. If the answer is yes, then in step 604, UE continues the PLMN selection procedure by searching for NR cells, e.g., using the frequency band and PLMN ID carried by the assistance information. After finding a suitable NR cell, in step 605, UE determines whether to access for standalone or non-standalone option. If standalone, then in step 611, UE connects with 5G CN under option 2. If non-standalone, then in step 612, UE connects with 5G CN under option 4.

If the assistance information does not provide any neighboring NR cell configuration, then UE knows that no 5G CN services are available. As a result, UE goes to step 606 and continues the PLMN selection procedure by searching for eNB and LTE cells. In step 607, UE checks whether a suitable LTE cell is found. If suitable LTE cell is found, then in step 608, UE determines whether to access for standalone or non-standalone option. If standalone, then in step 613, UE connects with EPC under option 1. If non-standalone, then in step 614, UE connects with EPC under option 3. If UE does not find any suitable LTE cell in step 607, then UE may try searching UMTS/GSM for receiving 3G/2G services.

FIG. 7 illustrates one embodiment of providing assistance information by an LTE base station for enabling EN-DC configuration in PLMN selection. In step 701, UE starts PLMN selection by searching for an LTE cell served by an LTE eNB. Under certain network deployment scenario and geographic location, it may be faster for UE to search for an LTE eNB first. Further, LTE base station may provide additional assistance information with respect to neighboring ENDC supported LTE cells. In step 702, UE receives and analyzes assistance information from eNB. In step 703, UE determines whether LTE is preferred and whether there are neighboring ENDC supported LTE cells available or neighboring new radio (NR) cells supporting 5G core network services available. If NR cell is preferred and available, then in step 704, UE searches for NR cell. If LTE cell is preferred and ENDC is available, then in step 705, UE searches for the proper LTE cell for ENDC and connects with EPC.

The assistance information may further include regional RAT preference. Currently RAT preference is UE internally kept and can be provided in its SIM/USIM card on the basis of PLMN. The network may update the RAT preference via SIB or downlink message on the basis of a smaller region (e.g., a tracking area) according to network deployment. For example, the network may provide updated HPLMN RAT preference to UE. The new configuration will preempt the default configuration stored in SIM/USIM and UE may apply the new strategy in the next PLMN searching procedure. For example, in environment with NR cells for option 3 only, network may update the preference from “NG-RAN>LTE” to “LTE>NG-RAN”. As a result, UE will search LTE first in subsequent PLMN selection procedure until the RAT preference is updated again, e.g., when UE moves to a new environment with option 2 NR cell.

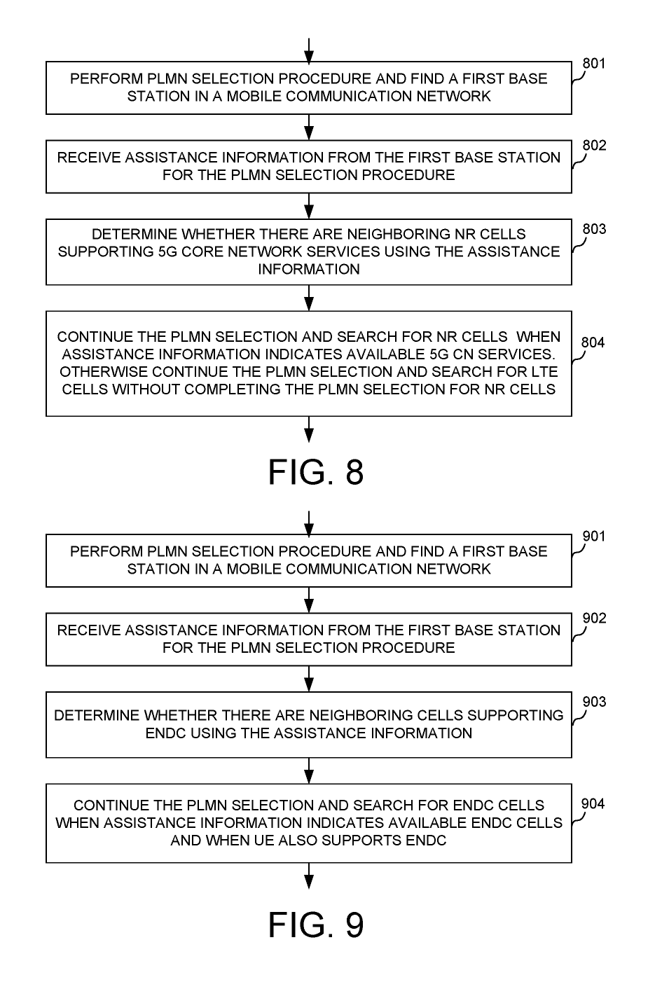

FIG. 8 is a flow chart of a method of receiving assistance information by a UE to determine proper RAT preference and improve PLMN selection performance in accordance with a novel aspect. In step 801, a UE performs a public land mobile network (PLMN) selection procedure and finding a first base station in a mobile communication network. In step 802, the UE receives assistance information from the first base station for the PLMN selection procedure. In step 803, the UE determines whether there are neighboring new radio (NR) cells supporting 5G core network services using the assistance information. In step 804, the UE continues the PLMN selection and searching for NR cells when the assistance information indicates available 5G core network services. Otherwise the UE continues the PLMN selection and searching for LTE cells without completing the PLMN selection searching for NR cells.

FIG. 9 is a flow chart of a method of receiving assistance information by a UE to determine dual connectivity options and improve PLMN selection performance in accordance with a novel aspect. In step 901, a UE performs a public land mobile network (PLMN) selection and finding an LTE base station in a mobile communication network. In step 902, the UE receives assistance information from the LTE base station for the PLMN selection. In step 903, the UE determines whether there are neighboring cells supporting EUTRA-NR dual connectivity (ENDC) using the assistance information. In step 904, the UE continues the PLMN selection and searching for ENDC cells when the assistance information indicates available ENDC cells and when the UE also supports ENDC.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing a public land mobile network (PLMN) selection procedure and finding a first base station by a user equipment (UE) in a mobile communication network;
receiving assistance information from the first base station for the PLMN selection procedure;
determining whether there are neighboring new radio (NR) cells supporting 5G core network services using the assistance information; and
continuing the PLMN selection and searching for NR cells when the assistance information indicates available 5G core network services, otherwise continuing the PLMN selection and searching for LTE cells without completing the PLMN selection for NR cells.

2. The method of claim 1, wherein the UE has a default radio access technology (RAT) priority order for the PLMN selection procedure, wherein the default RAT priority order is 5G>4G>3G>2G.

3. The method of claim 2, wherein the UE can override the default RAT priority order using the assistance information to improving the PLMN selection performance.

4. The method of claim 1, wherein the first base station is an NR base station.

5. The method of claim 1, wherein the first base station is an LTE base station.

6. The method of claim 1, wherein the assistance information comprises frequency and band information and a PLMN ID.

7. The method of claim 1, wherein the assistance information comprises radio access technology (RAT) information and subcarrier spacing (SCS) information.

8. The method of claim 7, wherein the RAT information comprises a regional RAT preference for the UE.

9. A User Equipment (UE), comprising:
performing a public land mobile network (PLMN) selection procedure and finding a first base station by a user equipment (UE) in a mobile communication network;
a radio frequency (RF) receiver that receives assistance information from the first base station for the PLMN selection procedure;
a configuration and control circuit that determines whether there are neighboring new radio (NR) cells supporting 5G core network services using the assistance information; and
continuing the PLMN selection and searching for NR cells when the assistance information indicates available 5G core network services, otherwise continuing the PLMN selection and searching for LTE cells without completing the PLMN selection for NR cells.

10. The UE of claim 9, wherein the UE has a default radio access technology (RAT) priority order for PLMN selection, wherein the default RAT priority order is 5G>4G>3G>2G.

11. The UE of claim 10, wherein the UE can override the default RAT priority order using the assistance information to improving the PLMN selection performance.

12. The UE of claim 9, wherein the first base station is an NR base station.

13. The UE of claim 9, wherein the first base station is an LTE base station.

14. The UE of claim 9, wherein the assistance information comprises frequency and band information and a PLMN ID.

15. The UE of claim 9, wherein the assistance information comprises radio access technology (RAT) information and subcarrier spacing (SCS) information.

16. The UE of claim 15, wherein the RAT information comprises a regional RAT preference for the UE.

17. A method, comprising:
performing a public land mobile network (PLMN) selection and finding an LTE base station by a user equipment (UE) in a mobile communication network;
receiving assistance information from the LTE base station for the PLMN selection;
determining whether there are neighboring LTE cells supporting EUTRA-NR dual connectivity (ENDC) or neighboring new radio (NR) cells supporting 5G core network services using the assistance information; and
continuing the PLMN selection and searching for ENDC cells when neighboring LTE cells supporting ENDC are available, or searching for NR cells when neighboring NR cells are available.

18. The method of claim 17, wherein the UE is served by an LTE cell as an anchor cell and by an NR cell as a secondary cell for improved data throughput.

19. The method of claim 17, wherein the assistance information further comprises frequency and band information and a PLMN ID.

20. The method of claim 17, wherein the assistance information further comprises radio access technology (RAT) information and subcarrier spacing (SCS) information.
